(19) United States
(12) Patent Application Publication
(10) Pub. No.: US 2021/0123630 A1
(43) Pub. Date: Apr. 29, 2021

(54) Variable slot length adjustment vent

(71) Applicant: Nevin Wagner, Manheim, PA (US)

(72) Inventor: Nevin Wagner, Manheim, PA (US)

(21) Appl. No.: 17/121,205

(22) Filed: Dec. 14, 2020

Related U.S. Application Data
(63) Continuation-in-part of application No. 15/917,188, filed on Mar. 9, 2018.
(60) Provisional application No. 62/469,676, filed on Mar. 10, 2017.

(51) Int. Cl. F24F 13/14; A01K 1/00

(52) U.S. Cl. CPC F24F 13/14; F24F 2007/0025; A01K 1/0064

(57) ABSTRACT

A vent with an adjustable baffle is disclosed. As the baffle is rotated away from the frame of the vent a corresponding opening is formed though which air may flow. The vent further has features which constrict the width of the opening in response to how far the baffle is opened. When the baffle is partially opened, these constricting features block a portion of the vent opening resulting in an opening of a certain width. The baffle can be opened further to a point beyond the constricting feature so that a wider vent opening is created. The design allows for more, and easier control of air flow in a system and can increase the distance air coming though the vent moves into the space before it descends.

### FIELD OF THE INVENTION

The subject matter of this application pertains to devices and methods for controlling air flow in buildings. More precisely, the subject matter of this application pertains to adjustable vents. Even more precisely, the subject matter of this application pertains to adjustable air flow vents in which the width of the vent opening is dependent on the degree of displacement of the baffle. The subject matter of this application may be of particular value to livestock housing environments such as, e.g., poultry houses.

### BACKGROUND

Any sealed system containing animals will have a gradual decrease in oxygen concentration and an increase in carbon dioxide concentration as a function of the metabolic needs of the contained animals. Eventually, the oxygen level will drop too low to support animal life. Man-made structures such as poultry houses are far from perfectly sealed systems and are generally air-permeable enough to support animals housed inside. However, even if a poultry house had large open windows ensuring adequate oxygen levels, the inconsistent airflow would present other problems.

Airflow is responsible for much more than just ensuring adequate oxygen levels, and just like a fan in a bedroom on a hot summer night, the airflow in a room or building removes excess heat and humidity.

Accordingly, poultry houses do not simply have a completely passive, open window air-circulation system and the airflow is determined by a negative pressure system. A series of fans blow air out of the poultry house and the resulting negative pressure pulls in air from a battery of upwardly opening vents along the walls. The airflow is therefore determined by two factors, the pressure caused by air being expelled and the amount of outside air that can flow through the vents.

The airflow in a building such as livestock housing largely controls both the temperature radiated by the animals and other sources, and the humidity exhaled by the animals and from evaporation. Other problems that may be caused by poor airflow such as the spread of disease and low oxygen levels are secondary to temperature and humidity control and airflow rates sufficient for temperature and humidity control are likely sufficient for disease mitigation and maintaining oxygen concentration.

In warmer weather, more rapid air flow will help keep the temperature and humidity within the livestock house from rising too high; in cold weather, the airflow requirements are more complicated.

Cold air is more dense than warm air, so incoming cold air will tend to drop to the floor and push warm air from the heating system and the birds being towards the ceiling. To keep the birds warm, cold air should blow into the building with sufficient speed so that it moves (or is “thrown”) above the animals and toward the center of the building. The incoming air begins to warm as it moves toward the center of the room, which is also where the warmest air tends to collect so by the time the newly introduced air reaches the floor it has warmed and the temperature decrease at the floor has been minimized.

The throw of incoming air is most dependent on the temperature difference between inside and outside the house, the negative pressure, and the amount the vents are opened. Air density is correlated with air temperature, so air becomes more dense as it becomes colder. Therefore when the difference between inside and outside temperatures is greatest, the relative air densities are greatest, and incoming cold air will tend to fall before it can be warmed. That tendency can be mitigated by increasing the speed of the entering air by increasing the negative pressure. Adjusting the vents to manipulate the speed of incoming air works to a point, but can have unexpected effects.

When air enters through openings in standard vents of less than about an inch, the air tends to travel along the wall instead of being thrown toward the center of house. Much larger openings of 2-3 inches or more cause the air to be initially thrown in the right direction but the speed of the incoming air through an opening of that size can be too slow to reach far before dropping. Openings of 1-3 inches are therefore typically advised for getting the best throw, although then the volume of cold air being pulled into a house where each vent is open 1-3 inches may drop the temperature in the house too low and require greater expenditures for heating.

One solution would be to only open some of the inlets 1-3 inches and leave other inlets closed. Unfortunately that solution has its own problems. Such selective opening is at odds with common practices which, in order to reduce the cost and time needed to manipulate the vents' baffles, employ a single opening means that opens or closes a battery of vents in unison. Further, in poultry houses with multiple batteries of vents, opening a few can cause unusual air flow patterns such as hot or cold spots or areas of greater air velocity.

In order for optimal air distribution, the vents should be sufficiently open to cause adequate throw towards the center of the room, but not so widely open that the volume of air coming in is greater than what can be warmed with minimal expenditure. Further, an optimal air inlet system would have somewhat equally spaced vents and large batteries of vent baffles could be adjusted in unison.

### SUMMARY

The subject matter of this application is related to ventilation devices and methods. More precisely, the subject matter of this application pertains to vents and vent baffles for use in animal housing, particularly poultry housing.

The subject matter of this application pertains to vents and vent baffles comprising one or more structural features which allow the baffle to be adjusted so that an opening though which air can flow is present, but this opening does not extend across the entire length of the baffle. Opening the baffle further exposes an opening extending further across the baffle's length though which air can flow. The partial opening allows for the vent or vents to be opened enough for air to move into the poultry house with sufficient throw towards the building's ceiling, but without allowing air across the entire length of the baffle to enter. In this way, sufficient air is able to enter the building so that it can warm above the birds before reaching the floor, but air flow is also restricted so that entering cold air does not overpower the heating capacity of the poultry house.

The subject matter of this application is able to control airflow without the need for more complicated baffle opening technology than that already commonly in use in poultry houses.

### BRIEF DESCRIPTION OF THE DRAWINGS

FIG. 1 is a view of the disclosed vent in a wall with the baffle fully closed.

FIG. 2 is a view of the disclosed vent frame isolated from the baffle.

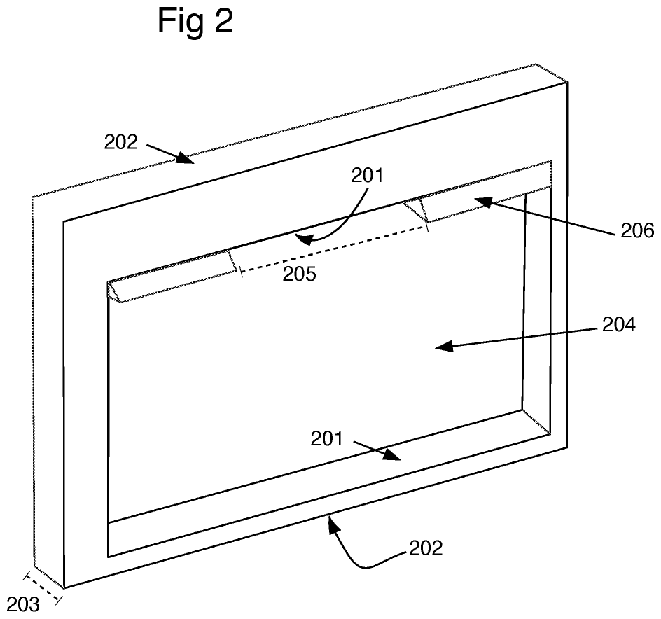

FIG. 3 is a view of the disclosed baffle, isolated from the vent frame.

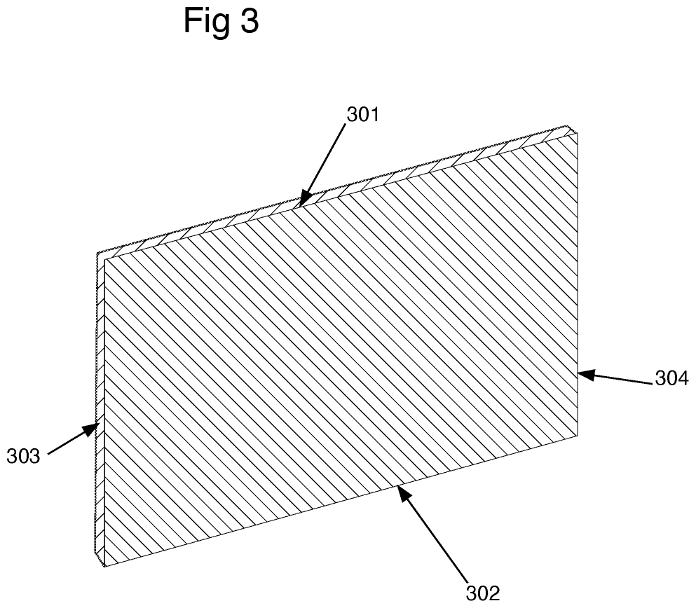

FIG. 4 is a view of an isolated vent with the baffle in the first position.

FIG. 5 is a view of an isolated vent with the baffle is in the second position.

FIG. 6 is a partial mid-section (at a-a) of the disclosed vent with a closed baffle.

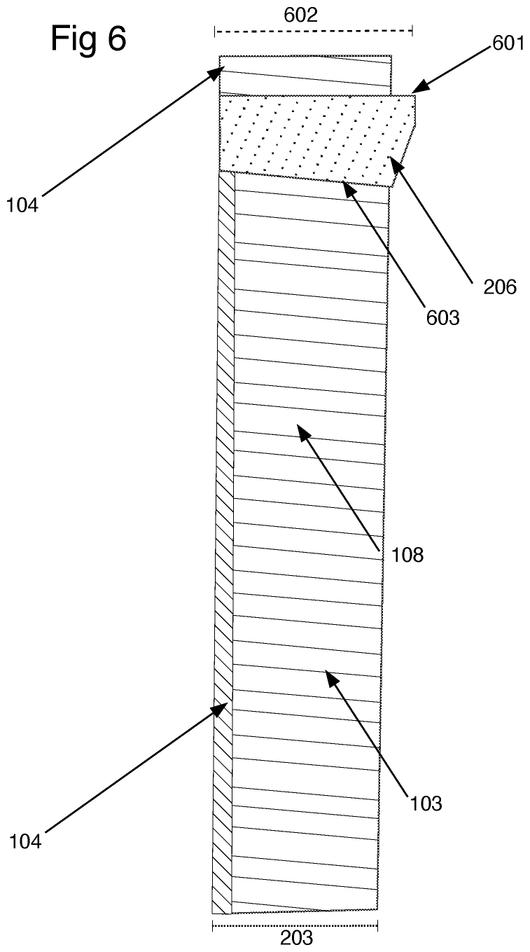

FIG. 7 is a partial mid-section (at b-b) of the disclosed vent with the baffle in the first position.

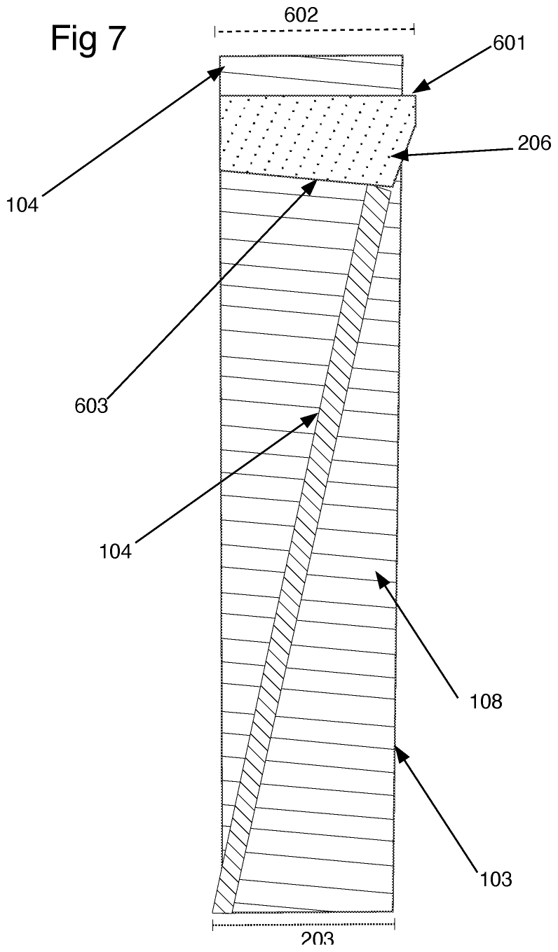

FIG. 8 is a partial mid-section (at c-c) of the disclosed vent with the baffle in the second position.

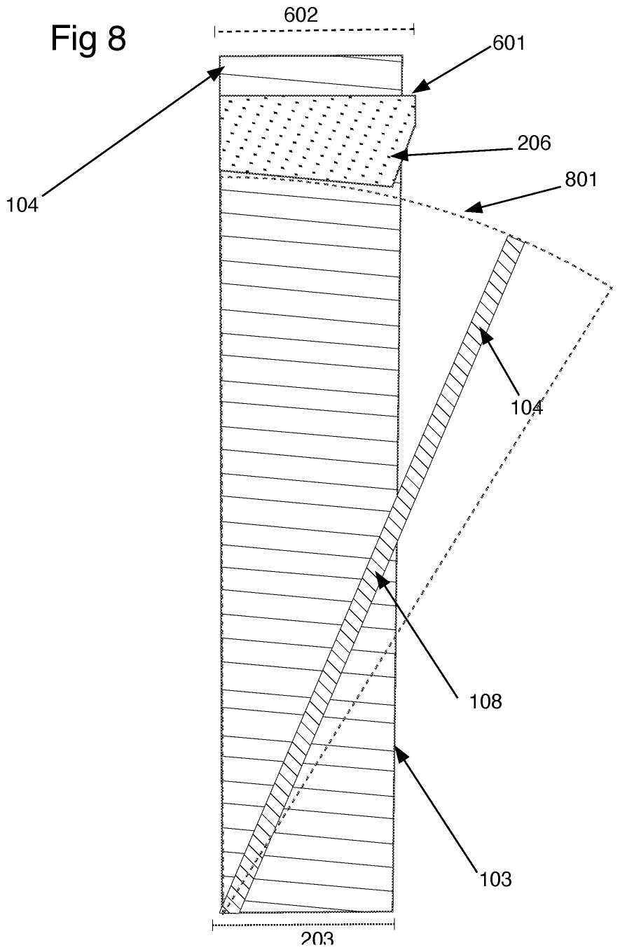

### DETAILED DESCRIPTION OF THE DRAWINGS

The following description and referenced drawings illustrate embodiments of the application's subject matter. They are not intended to limit the scope. Those familiar with the art will recognize that other embodiments of the disclosed method are possible. All such alternative embodiments should be considered within the scope of the application's claims.

Each reference number consists of three digits. The first digit corresponds to the number of the figure in which that reference number is first shown. Reference numbers are not necessarily discussed in the order of their appearance in the figures. Drawings are not necessarily to scale.

As used here, a “wall” is a substantially solid structure that blocks nearly all air from passing though it and includes roofs and ceilings as well as the vertical structures. A “vent” is structure which, when mounted in a hole in a wall, can control the passage of air though said space via one or more air blocking means. A “frame” is a the portion of a vent which contacts the physical structure surrounding said hole in a wall. A “baffle” is a movable item such as a slat, that can pivot on an axis and which can restrict the flow of air though an associated vent. In most embodiments, the baffle is attached to the frame of the vent. An “airflow channel” is the portion of the vent which is not blocked by a baffle. An “airflow restrictor” is a structure attached to a baffle or a frame which lengthens or shortens the width of the airflow channel as a function of the position of the baffle. In some preferred embodiments, two airflow restrictors are separated by an “restrictor gap”. The singular terms “airflow restrictor” and “restrictor gap” should be understood to include the plural where the context permits unless specifically stated.

The baffle may have an nigh-infinite number of positions, however for clarity three positions are discussed: “closed” is where the baffle is parallel to the wall and prevents nearly all air from moving through the vent; “first position” is where the baffle is in such a position to form an airflow channel solely within the restrictor gap; “second position” is when the baffle is in such a position to form an airflow channel extending across the baffle length.

There are some embodiments of the subject matter of this application in which the airflow restrictor is stationary and also in which the airflow restrictor can move as the baffle is adjusted. Either type of airflow restrictor may be attached the frame or to the baffle. Accordingly, the drawings are just examples of preferred embodiments and should not be construed to limit the scope of the claims. Drawings are not to scale.

A vent (101) in a wall (102) is comprised of a frame (103) and a baffle (104).

The frame is itself comprised of four sides, a first side (105), a second side (106), a third side (107), and a fourth side (108). Each of these four sides comprises an inside face (e.g., 201), an outer face (e.g., 202), and a depth (e.g., 203). Said first face of the first side and the inner face of the second side are parallel. Said first face of the third side and the inner face of the fourth side are parallel. The frame outlines an airflow channel (204).

The baffle is comprised of a first edge (301), a second edge (302), a third edge (303), and a fourth edge (304). The dimensions of the baffle are such that the baffle can completely or almost completely block the airflow channel outlined by the frame.

The inner face of the first side of the frame comprises an airflow restrictor (206). In a most preferred embodiment, said airflow restrictor is a wedge having a first face (601), a length (402), a depth (602), and a baffle edge (603). The first face of the airflow restrictor is continuous with or abuts the inner face of the first side of the vent. Optimally, said depth of the airflow restrictor is approximately equal to the depth of the third and fourth sides of the frame.

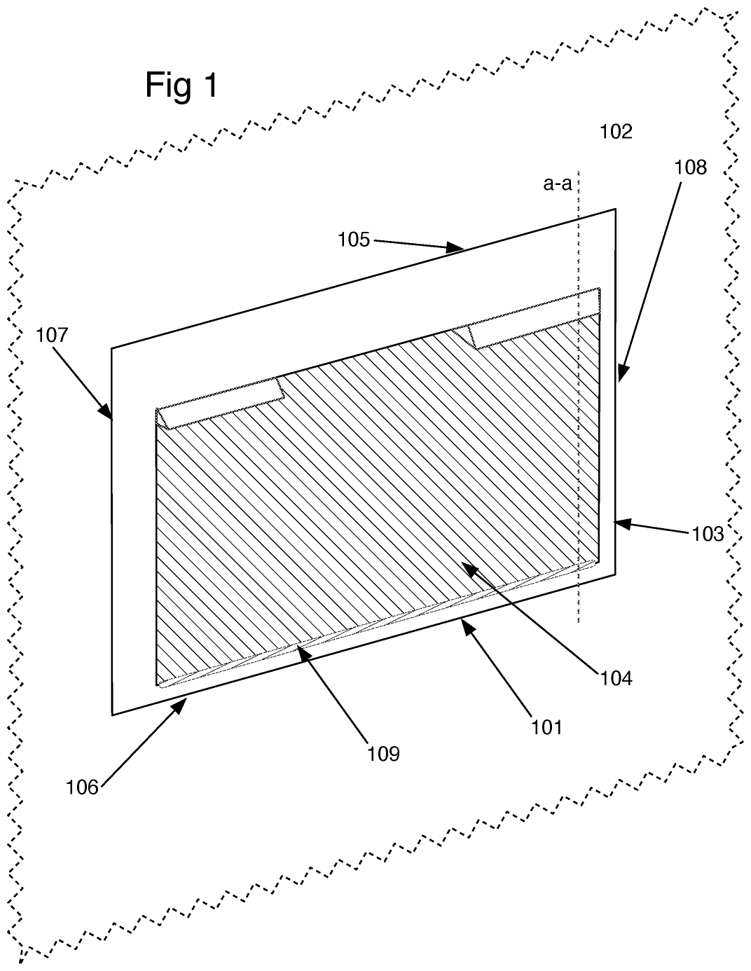

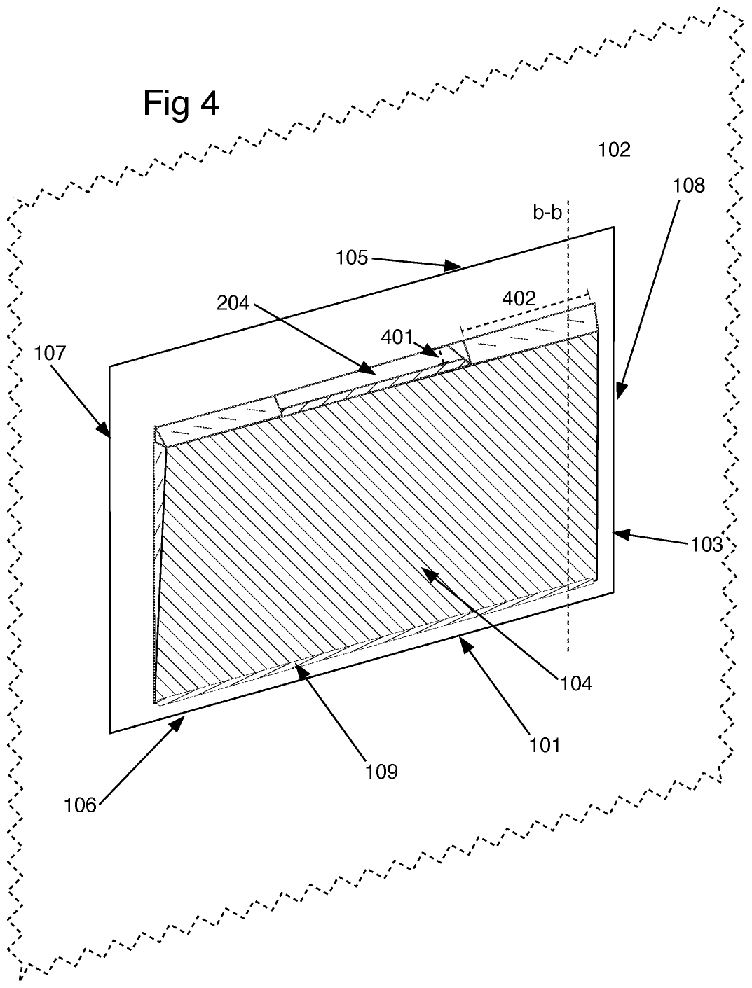

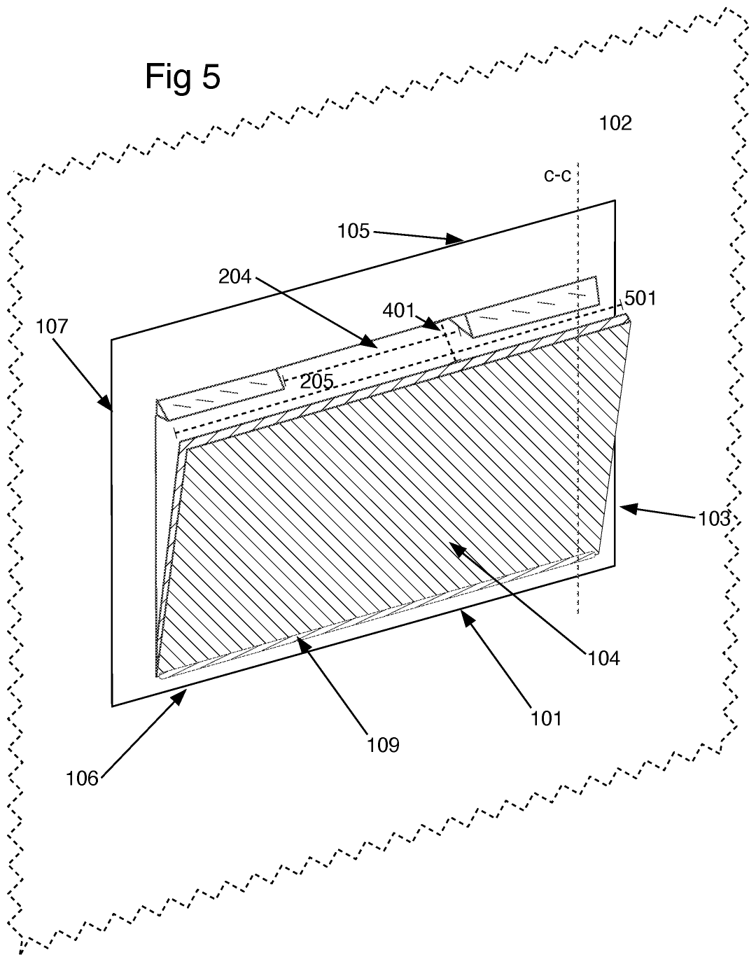

Said baffle (104) is attached the frame and can move in relation to the frame. Most commonly the second edge of the baffle is attached to the second side of the frame by a hinge (109). The baffle is able to pivot along the hinge. As the baffle pivots, the first edge of the baffle defines a baffle arc (801). Along the path of the baffle arc are at least three positions of the baffle: closed (FIG. 1), the first position (FIG. 4), and the second position (FIG. 5).

In a highly preferred embodiment, the inner face of the first side of the frame comprises two airflow restrictors, parallel to the inner face of the first side of the frame and separated by a restrictor gap (205). The baffle edge of each said airflow restrictor is beveled, said bevel being approximately tangent to the baffle arc.

When the baffle is in the closed position (FIG. 1) there is no airflow channel and consequently no airflow though the vent except for perhaps through cracks or gaps providing insignificant airflow.

As work is done on the baffle to rotate it along the axis of the hinge (the vertex) an airflow channel is formed between the first edge of the baffle and the first side of the frame. This airflow channel has a length (205) equal to the length of the restrictor gap and a width (401) defined as the space between the top edge of the baffle and the first side of the frame. This first position (e.g., FIG. 1) is defined as any place along the baffle arc in which the bevel edge of the airflow restrictor blocks significant airflow through the first side of the frame and the first edge of the baffle, but an airflow channel exists in the space along the top edge of the baffle not encumbered by an airflow restrictor.

As further work is done on the baffle to rotate it along the axis of the hinge it moves into second position (FIG. 5) in which the distance between the first edge of the baffle and the first side of the frame increases beyond the depth of the airflow restrictor, forming an airflow channel across the entire first edge of the baffle (501) in addition to the airflow channel between the restrictor gap (205) as disclosed above.

In this manner, a single actuator working on a baffle causes two-dimensional vent opening, first by exposing an air channel formed between airflow restrictors and the distance between the first edge of the baffle and the first side of the frame, and with further work exposing a channel formed across the first edge of the baffle.

The disclosed two-dimensional vent opening allows a user to more carefully adjust the airflow through the vent and further allows one to take manipulate the throw of air passing through the vent without needing to open a larger airflow channel across the entire baffle.

In mostly highly preferred embodiments, the aggregate length of all airflow restrictors is between 40% and 70% of the inside length of the first side of the frame. Further in most highly preferred embodiments the depth of the airflow restrictors is sufficient to block airflow between the airflow restrictor and the top edge of the baffle when the vertex is between 0° and 30°. Our testing has determined that such ranges offer a range of airflow options sufficient for most uses and that deviation from the disclosed ranges offers no obvious advantage. However, there may exist applications in which deviation from the disclosed ranges is advantageous. Accordingly, the disclosed ranges are disclosed to inform, but should not be construed to limit the scope of the claims unless otherwise specified.

I claim:

1. A vent comprising a frame and a baffle,
a. said frame comprises a first side, a second side, a third side, and a fourth side;
i. each said side of the frame comprises an inner face, an outer face, an inside length, and a depth;
a) said inner face of the first side and said inner face of the second side being parallel;
b) said inner face of the third side and said inner face of the fourth side being parallel;
ii. said inner face of the first side of the frame comprising at least one airflow restrictor;
a) each said airflow restrictor comprising a length, a depth, and a baffle face;
(1) said length being parallel to the inner face of the first side of the frame;
(2) said aggregate length of all airflow restrictors being less than the inside length of the first side of the frame;
b. said baffle comprises a first edge and a second edge;
i. Said second edge of the baffle attached to the frame and pivotable along an axis located at the inner face of the second side of the frame;
ii. Said baffle further comprising an angle between 0° and at least 30°;
a) said angle having a vertex along said axis;
b) Said first edge of the baffle defining a baffle arc as the angle changes.

2. The vent of claim 1 in which said vent is closed when said angle is 0°.

3. The vent of claim 1 in which an air channel is exposed as the angle increases and the distance between the top edge of the baffle and the inner face of the first side of the frame increases.

4. The vent of claim 1 in which
a. each said baffle face of an airflow restrictor largely abuts the first edge of the baffle when said angle is between than 0° and less than a maximum restriction angle of 180°
b. in which the depth of the first side of the frame is approximately equal to the distance traveled by the first edge of the baffle when said baffle is pivoted to said maximum restriction angle.

5. The vent of claim 1 in which
a. each said baffle face of an airflow restrictor largely abuts the first edge of the baffle when said angle is between 0° and a maximum restriction angle between about 5° and 30, and
b. in which the depth of the first side of the frame is approximately equal to the distance traveled by the first edge of the baffle when said baffle is pivoted to said maximum restriction angle.

6. The vent of claim 1 in which the baffle edge of the airflow restrictor is tangential to said baffle arc.

7. A vent comprising a frame, a baffle, and at least one airflow restrictor,
a. said baffle comprising a first edge having a length, a closed position, a first position, and a second position,
b. each said airflow restrictor comprising a length,
c. said first position of the baffle creating an airflow channel having the dimensions of the length of the first edge of the baffle minus the length of the airflow restrictor or restrictors and the space between the first edge of the baffle and the frame, and
d. said second position of the baffle creating an airflow channel comprising a first width equal to the length of the first edge of the baffle minus the length of the airflow restrictor or restrictors and a second width equal to the length of the first edge of the baffle.
